(19) United States
(12) Patent Application Publication
(10) Pub. No.: US 2012/0329084 A1
(43) Pub. Date: Dec. 27, 2012

(54) HIGH THROUGHPUT SCREENING OF LACTIC ACID-PRODUCING MICROORGANISM

(75) Inventors: Hwa Young CHO, Hwaseong-si (KR); Byung Jo YU, Hwaseong-si (KR); Jae Chan PARK, Yongin-si (KR); Sung Min PARK, Yongin-si (KR); Hyun Min KOO, Seoul (KR); Ju Young LEE, Daegu (KR)

(73) Assignee: SAMSUNG ELECTRONICS CO., LTD., Suwon-si (KR)

(21) Appl. No.: 13/404,635

(22) Filed: Feb. 24, 2012

(30) Foreign Application Priority Data
Jun. 23, 2011 (KR) 10-2011-0061366

(51) Int. Cl. G01N 21/80

(52) U.S. Cl. 435/29

(57) ABSTRACT

A high throughput screening system and method of a lactic acid-producing microorganism using a mixture of at least two pH indicators are provided. The method may be useful in determining a production amount of a lactic acid, which is a final metabolite secreted by the microorganism, more accurately, rapidly and easily.

### CROSS-REFERENCE TO RELATED APPLICATION

This application claims priority to Korean Patent Application No. 10-2011-0061366, filed on Jun. 23, 2011, and all the benefits accruing therefrom under 35 U.S.C. §119, the content of which in its entirety is herein incorporated by reference.

### BACKGROUND OF THE INVENTION

Lactic acid is a organic acid that plays a role in various industry such as cosmetics, chemical, metal, electronic, textile, dyeing and pharmaceutical industry as well as in various food additives such as preservatives, flavoring agents and acidulents. Further, lactic acid is used also as a monomer for producing polylactic acid (“PLA”), which is a biodegradable plastic. Recently, this kind of plastic is a good option for substituting conventional plastic produced from petroleum oil because of low emission of carbon dioxide.

Specifically, lactic acid has a hydroxyl group and a carboxyl group, making it greatly reactive such that it plays a important role as a source material on producing chemical including acetaldehyde, polypropylene glycol, acrylic acid, 2,3-pentathione as well as polylactic acid. Lactic acid is also used for producing ethyl lactate, which is a biodegradable and non-toxic solvent and used in electronic manufactures, paint or textile industry, detergents or printing industry.

High throughput screening is a method for scientific experimentation used in relevant to the fields of biology and chemistry, which allows a researcher to quickly conduct of biochemical, genetic or pharmacological tests.

In order to screen a desired strain from a large number of strain candidates, experiments on the strain candidates should be conducted using a high-performance liquid chromatography (HPLC) method, which has been generally used to screen a lactic acid-producing microorganism. Since a time of approximately 30 minutes is required to screen only one test sample through one experiment using the HPLC method, a great amount of time is required to screen desired lactic acid-producing microorganisms from the a large number of strain candidates.

Therefore, development of a high throughput screening method is required to screen a large amount of lactic acid-producing microorganisms within a short time.

### SUMMARY

A high throughput screening method of a lactic acid-producing microorganism using a pH indicator is provided.

According to an aspect, a screening system of a lactic acid-producing microorganism including a lactic acid-producing microorganism, a medium, and at least two pH indicators is disclosed.

According to another aspect, a screening method of a lactic acid-producing microorganism including adding at least two pH indicators to a medium, incubating a lactic acid-producing microorganism in the medium to which the at least two pH indicators are added, and measuring a lactic acid production amount of the microorganism by observing a change in color of the pH indicators is disclosed.

According to certain aspects of the method, a lactic production amount of an acid, which is a final metabolite secreted by the microorganism, may be determined more accurately, rapidly and/or easily.

### BRIEF DESCRIPTION OF THE DRAWINGS

The patent or application file contains at least one drawing executed in color. Copies of this patent or patent application publication with color drawings will be provided by the Office upon request and payment of the necessary fee.

The above and other aspects of this disclosure will become more readily apparent by describing in further detail non-limiting example embodiments thereof with reference to the accompanying drawings, in which:

FIG. 1 shows a change in color of a Bromocresol green indicator with increasing concentration of lactic acid.

FIG. 2 shows a change in color of a methyl red indicator with increasing concentration of lactic acid.

FIG. 3 shows a change in color of a mixed Bromocresol green/methyl red indicator with increasing concentration of lactic acid.

### DETAILED DESCRIPTION

Unless defined otherwise herein, all technical and scientific terms used herein have the same meaning as commonly understood by one of ordinary skill in the art to which this disclosure belongs. Various scientific dictionaries that include the terms included herein are well known and available to those in the art. Although any methods and materials similar or equivalent to those described herein find use in the practice or testing of the disclosure, some preferred methods and materials are described. Accordingly, the terms defined immediately below are more fully described by reference to the Specification as a whole. It is to be understood that this disclosure is not limited to the particular methodology, protocols, and reagents described, as these may vary, depending upon the context they are used by those of skill in the art.

As used herein, the terminology is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprises” and/or “comprising,” or “includes” and/or “including” when used in this specification, specify the presence of stated regions, integers, steps, operations, elements, and/or components, but do not preclude the presence or addition of one or more other regions, integers, steps, operations, elements, components, and/or groups thereof.

Numeric ranges are inclusive of the numbers defining the range. It is intended that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

The headings provided herein are not limitations of the various aspects or embodiments of the invention which can be had by reference to the specification as a whole.

pH Indicator

A high throughput screening method of a lactic acid-producing microorganism using a pH indicator is provided.

As used herein, the term “pH indicator” refers to a chemical compound, which causes the color of the solution to change depending on a concentration of hydronium ions (H3O+) or hydroxide ions (OH—).

The pH indicator may undergo a change in color from a first color to a second color, from colorlessness to a color, or from a color to colorlessness, over a certain predetermined pH range. This range is referred to as a pH transition range, and the pH transition range varies according to kinds of indicators. The change in color from the first color to the second color is visually detectable, i.e., the change occurs within the visible spectrum. A color that appears at a value lower than this pH transition range is referred to as an acid color, and a color that appears at a value higher than this pH transition range is referred to as a base color or an alkaline color.

The pH indicators are divided into acid indicators and base indicators according to acidity and basicity, and divided into phthalein-based indicators, sulfonephthalein-based indicators, benzoin-based indicators, azo-based indicators, triphenylmethane-based indicators, and nitro-based indicators according to their structures.

The pH indicators generally have a transition range of 1 to 2 pH units, and thus may be used to determine the presence of acid.

For example, a Bromocresol green (C21H14Br4O5S) indicator is an acid indicator and a solfone phthalein-based indicator, which changes in color at pH 3.8 to pH 5.4, as follows:

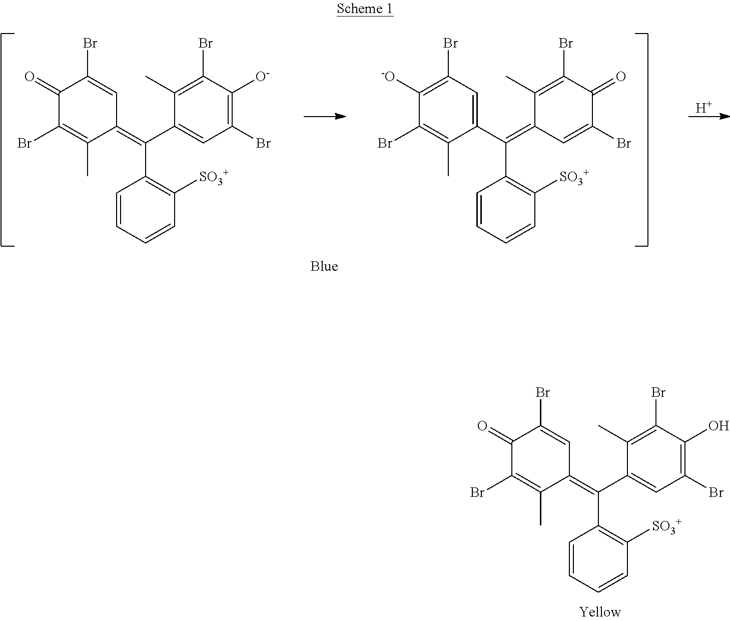

A methyl red (C₁₅H₁₅N₃₂) indicator is an acid indicator and an azo-based indicator, which changes in color at pH 4.4 to pH 6.2, as follows:

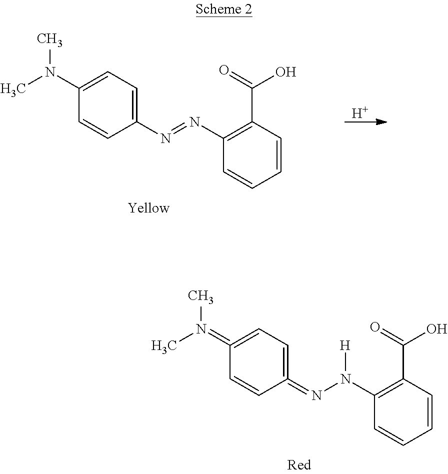

The Bromocresol green indicator gradually changes in color from blue to yellow as a lactic acid production amount of the strain is increased, and the methyl red indicator gradually changes in color from yellow to red.

However, since the Bromocresol green indicator has a narrow pH transition range of 1.6 pH units from blue to yellow, the production of acid may be determined by observing the change in color, but it is difficult to determine the change in pH according to an increase in acid production amount.

In addition, since the methyl red indicator has a narrow pH transition range of 1.8 pH units from yellow to red, the production of acid may be determined by observing the change in color, but it is difficult to determine the change in pH according to an increase in acid production amount.

Therefore, a method of determining a production amount of a lactic acid which is a final metabolite secreted by the microorganism is required.

Screening System of Lactic Acid-Producing Microorganism

According to an exemplary embodiment, a screening system of a lactic acid-producing microorganism is provided. The screening system may include a lactic acid-producing microorganism, a medium, and a mixture of at least two pH indicators.

As used herein, the term “lactic acid” refers to a carboxylic acid represented as a chemical formula C₃H₆O₃, and it has a hydroxyl group adjacent to the carboxyl group. Lactic acid is also called 2-hydroxypropanoic acid.

As used herein, the term “lactic acid-producing microorganism” refers to any microorganism that produces a lactic acid as a main metabolite through fermentation of a carbon source.

As used herein, the term “strain” refers to a prokaryotic or eukaryotic microorganism that produces a lactic acid as a main metabolite through fermentation of a carbon source.

For example, the prokaryotic microorganism may include, but is not limited to, at least one selected from the group consisting of Bacillus sp., Streptococcus sp., Streptomyces sp., Staphylococcus sp., Enterococcus sp., Lactobacillus sp., Lactococcus sp., Clostridium sp., Geobacillus sp., Escherichia coli sp., Pseudomonas sp., Salmonella sp., Campylobacter sp., Helicobacter sp., Flavobactenum sp., Fusobacterium sp., Ilyobacter sp., Neisseria sp. and Ureaplasma sp.

Also, the eukaryotic microorganism may include, but is not limited to, at least one selected from the group consisting of Candida sp., Hansenula sp., Kluyveromyces sp., Pichia sp., Saccharomyces sp., Schizosaccharomyces sp., and Yarrowta sp.

The microorganism may include a wild-type strain, a mutant strain and/or a recombinant strain. The wild-type strain refers to a naturally occurring microorganism, the mutant strain refers to a microorganism whose genes or chromosomes are structurally changed, and the recombinant strain refers to a microorganism having a different genetic combination than wild-type strains due to the change in sequence of a certain gene or its recombination with other genes.

According to an exemplary embodiment, the strain is Escherichia coli. However, the foregoing examples of acid-producing microorganism strains are set forth for the purposes of illustrating the invention, and are not intended to limit the scope of the invention.

As used herein, the term “medium” refers to a solution in which the acid-producing microorganism can be cultured, which is obtained by removing all bacteria from a suitable solution by means of sterilization and then adding materials required to culture the strain.

As the medium for growth of the lactic acid-producing microorganism, any medium may be used as long as the medium is not hindered from detecting a lactic acid produced by the strain using a pH indicator. For example, the medium may include, but is not limited to, an MRS (deMan, Rogosa, and Sharpe) medium, an APT (All Purpose Tween) medium, tryptone glucose, a beef extract medium, a tryptone glucose yeast extract medium, a tomato juice agar, M9 minimal medium, and a Kang-Fung medium.

As used herein, the term “incubating” refers to the fermentable bioconversion of a carbon source into a desired final product in a reaction vessel. The bioconversion means that a carbon source is contacted with a strain so as to convert the carbon source into a desired final product.

The carbon source may be a suitable carbon source generally consumed by the strain, for example, hexose. The hexose may include, but is not limited to, at least one selected from the group consisting of glucose, gulose, sorbose, fructose, idose, galactose, mannose, 2-keto-L-gulonic acid, idonic acid, gluconic acid, 6-phosphogluconate, 2-keto-D-gluconic acid, 5-keto-D-gluconic acid, 2-ketogluconate phosphate, 2,5-diketo-L-gulonic acid, 2,3-L-diketogulonic acid, dehydroascorbic acid, erythorbic acid and D-mannonic acid, which may be used alone or in any combination.

According the exemplary embodiment, the medium is an M9 minimal medium. The foregoing examples of suitable mediums and carbon sources are set forth for the purposes of illustrating the invention, but are not intended to limit the scope of the invention.

As used herein, the term “at least two pH indicators” refers to a mixture of indicators having different or partially identical transition ranges, which provides a change in color in the visible spectrum. The pH indicators, also referred to herein as “mixed” pH indicators, are referred to as “mixed” or being in a “mixture” in the general sense that they are combined with one another. The terms “mixed” and “mixture” are, thus, used broadly in the context of the invention and encompass a combination of pH indicators regardless of the process by which the pH indicators are combined, and encompassing multiple pH indicators in a single solution.

The pH indicator may have a transition range less than a pH range of the medium so that the change in color of the pH indicator can be visually detected as colonies of the lactic acid-producing microorganism are grown.

For example, the at least two pH indicators may be independently at least two indicators selected from the group consisting of methyl violet, cresol red, thymol blue, erythrosine disodium, 2,6-dinitrophenol, 2,5-dinitrophenol, methyl yellow, tetrabromophenol blue, bromophenol blue, congo red, methyl orange, ethyl orange, alizarin red, sodium alizarin, Bromocresol green, methyl red, chlorophenol red, and Bromocresol purple, but is not limited thereto. The transition ranges of the pH indicators and colors according to the acidity are listed in the following Table 1.

TABLE 1

| Indicators | Acid color | Transition range | Base color |
|---|---|---|---|
| Methyl violet | Yellow | pH 0.0-pH 1.6 | Blue |
| Cresol red | Red | pH 0.2-pH 1.8 | Yellow |
| Thymol blue | Red | pH 1.2-pH 2.8 | Yellow |
| Erythrosine disodium | Orange | pH 2.2-pH 3.6 | Red |
| 2,6-dinitrophenol | Colorless | pH 2.4-pH 4.0 | Yellow |
| 2,5-dinitrophenol | Colorless | pH 2.4-pH 5.8 | Yellow |
| Methyl yellow | Red | pH 2.9-pH 4.0 | Yellow |
| Tetrabromophenol blue | Yellow | pH 3.0-pH 4.4 | Blue |
| Bromophenol blue | Yellow | pH 3.0-pH 4.6 | Jade green |
| Congo red | Violet | pH 3.0-pH 5.0 | Red |
| Methyl orange | Red | pH 3.1-pH 4.4 | Orange |
| Ethyl orange | Red | pH 3.4-pH 4.8 | Yellow |
| Alizarin red | Yellow | pH 3.7-pH 5.2 | Orange |
| Sodium Alizarin | Yellow | pH 3.7-pH 5.2 | Orange |
| Bromocresol green | Yellow | pH 3.8-pH 5.4 | Blue |
| Methyl red | Red | pH 4.4-pH 6.2 | Yellow |
| Chlorophenol red | Yellow | pH 5.0-pH 6.6 | Red |
| Bromocresol purple | Yellow | pH 5.2-pH 6.8 | Jade green |

The at least two pH indicators may have a pH transition range of 2.4 pH units or more, 2.6 pH units or more, 2.8 pH units or more, 3.0 pH units or more, 3.2 pH units or more or 3.4 pH units or more. When the pH transition range is set to 2.4 pH units or more, the lactic acid production amount according to the change in color may be determined more accurately and easily.

For example, when a first pH indicator, Bromocresol green, having a pH transition range of 1.6 pH units at pH 3.8 to pH 5.4, is mixed with a second pH indicator, methyl red, having a pH transition range of 1.8 pH units at pH 4.4 to pH 6.2, the mixed pH indicators may have a pH transition range of 2.4 pH units at pH 3.8 to pH 6.2. In this case, as a production amount of lactic acid secreted by the strain is increased, and the Bromocresol green/methyl red mixed pH indicators may change in colors in order of green, yellow, violet and red.

Also, when a first pH indicator, for example, thymol blue, having a pH transition range of 1.6 pH units at pH 1.2 to pH 2.8, a second pH indicator, for example, bromophenol blue, having a pH transition range of 1.6 pH units at pH 3.0 to pH 4.6, a third pH indicator, for example, Bromocresol green, having a pH transition range of 1.6 pH units at pH 3.8 to pH 5.4, and a fourth pH indicator, for example, Bromocresol purple, having a pH transition range of 1.6 pH units at pH 5.2 to pH 6.8, are mixed with each other, the mixed pH indicators may have a pH transition range of 5.6 pH units at pH 1.2 to pH 6.8. In this case, as a production amount of lactic acid secreted by the strain is increased, the thymol blue/bromophenol blue/Bromocresol green/Bromocresol purple mixed pH indicators may change in colors in order of red, orange, yellow, green and dark blue at the unit of approximately 1 pH unit from pH 1.2 to pH 6.8.

Screening Method of Lactic Acid-Producing Microorganism

According to another exemplary embodiment, a screening method of a lactic acid-producing microorganism using a mixture of at least two pH indicators is provided. The method may include adding the at least two pH indicators to a medium, incubating a lactic acid-producing microorganism in the medium to which the at least two pH indicators are added, and measuring a lactic acid production amount by observing a change in colors of the pH indicators.

Adding the at least two pH indicators to the medium may be performed, for example, by adding Bromocresol green and methyl red pH indicators to an M9 minimal medium. The pH indicators can be mixed first, then added to the medium, or the pH indicators can be added to the medium individually, simultaneously or sequentially in any order, to provide the mixture of pH indicators.

The Bromocresol green and the methyl red may be mixed at a ratio of about 2:1 to 10:1. More particularly, the Bromocresol green and the methyl red can be mixed at a ratio of about 2:1, 3:1, 4:1, 5:1, 6:1, 7:1, 8:1, 9:1 or 10:1, as well as ratios intervening between these values. Within this range, a change in color according to a change in pH may be clearly observed.

The pH indicators may be added at a content of about 0.005 to 0.2 parts by weight, based on 100 parts by weight of the medium. For example, the pH indicators can be added at about 0.005; 0.01, 0.02, 0.03, 0.04, 0.05, 0.1, 0.15, or 0.2 parts by weight, as well as at any content by weight intervening between these values.

Incubating the lactic acid-producing microorganism in the medium to which the at least two pH indicators are added may be performed, for example, by incubating a lactic acid-producing E. coli strain in a batch, semi-batch or continuous type process.

The batch-type incubation means an incubation in which a substrate in a solid or concentrated liquid form is added at the beginning of incubation. The batch-type incubation starts with inoculation of a cell in a medium, but continues without subsequent addition of nutrients such as supply of concentrated nutrients. The batch-type incubation is performed without regular addition or removal of a culture fluid or cell to/from a culture solution. Since the concentrations of nutrients or metabolites in the culture medium depend on an initial concentration in a batch-type vessel and a subsequent change in nutrient supply compositions by action of fermentation, it is impossible to subsequently add various analytes in a culture medium.

The semi-batch-type incubation means an incubation in which a substrate in a solid or concentrated liquid form is added intermittently or continuously during the incubation. The semi-batch-type incubation starts with inoculation of a cell in a medium, but continues with subsequent addition of nutrients such as supply of concentrated nutrients. Because the concentrations of nutrients or metabolites in the culture medium is immediately controlled or affected by a change in nutrient supply compositions in that there is no regular removal of culture fluid or cells from a semi-batch-type culture solution, it is advantageous to monitor and handle concentrations of the various analytes in the culture medium. The nutrient supply transferred to the semi-batch-type incubation is typically a concentrated nutrient solution containing an energy source, for example, carbohydrates; optionally, a concentrated nutrient solution to be transferred to the semi-batch-type incubation may contain amino acids, a lipid precursor and salts. In the semi-batch-type incubation, the nutrient supply is typically concentrated so that an increase in volume of the culture solution can be minimized while supplying sufficient nutrients for continuous growth of cells.

The continuous incubation means an incubation characterized by continuous inflow of liquid nutrients and continuous outflow of liquid. However, the nutrient supply is not necessarily a concentrated nutrient supply. Cell culture may be maintained under stable proliferation and growth conditions by continuously supplying a nutrient solution at substantially the same speed as those of cells being washed off by a consumed medium.

Measuring the lactic acid production amount by observing the change in colors of the pH indicators may be performed, for example, by analyzing the change in colors of the pH indicators according to the lactic acid production amount of the E. coli strain.

The mixed Bromocresol green/methyl red pH indicators changes in color in order of green, yellow, violet and red within a range of about pH 3.8 to about pH 6.2 as the lactic acid production amount of the E. coli strain is increased. Therefore, a concentration of lactic acid may be measured as listed in the following Table 2.

TABLE 2

lactic acid (g/L)

| | 0 | 1 | 4 | 8 | 16 | 32 |
|---|---|---|---|---|---|---|
| pH | 7.19 | 6.96 | 6.03 | 4.02 | 3.45 | 3.03 |

It can be estimated that the lactic acid production amount is approximately 0 to approximately 3 g/L when the color of the mixed pH indicators is green, the lactic acid production amount is approximately 4 to approximately 7 g/L when the color of the mixed pH indicators is yellow, the lactic acid production amount is approximately 8 to approximately 16 g/L when the color of the mixed pH indicators is violet, and the lactic acid production amount is approximately 16 to 32 g/L when the color of the mixed pH indicators is red.

Also, the change in colors of the pH indicators may be observed using an optical reader, for example, using any generally known detection technique including emission, absorbance, diffraction and the like. The optical reader measures color intensity in proportion to the absorbance. For example, the absorbance reading may be determined using a microplate reader (Dynex Technologies of Chantilly, Va. (Model #MRX)). Also, the absorbance reading may be determined using a conventional test known as “CIELAB.” In this method, three parameters, L*, a* and b* are defined, which correspond to three characteristics of colors perceived based on relative theory of color perception. These three parameters have the following meanings:

L*=Brightness (or Intensity of light), range of 0 to 100:0=Dark, 100=Bright;

a*=Red/Green axis, range of approximately −100 to 100: a positive value represents red, and a negative value represents green; and

b*=Yellow/Blue axis, range of approximately −100 to 100: a positive value represents yellow, and a negative value represents blue.

Since a CIELAB color space is visually uniform to some extent, a single number representing difference between two colors perceived by a human being may be calculated. This difference is represented by ΔE, and calculated by extracting the square root of the sum of three differences (ΔL*, Δa* and Δb*) between the two colors. In the CIELAB color space, each ΔE unit is substantially identical to the immediately perceived difference between two colors. Therefore, CIELAB is a means which is excellent for a target device-dependent color presentation system, which may be used as a reference color space for the purpose of presenting color management and change. In this case, the color intensity (L*, a* and b*) may be measured, for example, using a handheld spectrophotometer (Minolta Co. Ltd. of Osaka, Japan (Model# CM2600d)). Such an apparatus uses D/8 geometry according to CIE No. 15, ISO 7724/1, ASTME1164 and JIS Z8722-1982 (diffused light irradiation/8 degree measurement apparatus).

According to the method, the lactic acid-producing microorganism having the highest production amount may be screened within about 36 hours, about 24 hours, or about 12 hours.

According to an exemplary embodiment, a time required to screen the lactic acid-producing microorganism having the highest production amount is about 24 hours.

This indicates that the time required to screen the lactic acid-producing microorganism having the highest production amount is shortened to approximately 1/7 or less (about 1/10 or less, or even 1/20 or less) of the time required for such screening using HPLC alone. In other words, screening time is reduced by at least about 85%, at least about 86%, at least about 87%, at least about 88%, at least about 89%, at least about 90%, or even at least about 95% as compared to the time required for such screening using HPLC alone. This reduction in screening time makes it possible to shorten the time required to develop a new strain through primary screening of high-efficiency and high-throughput strain candidates in a mass-production system.

Hereinafter, the invention will be described in further detail with respect to exemplary embodiments. However, it should be understood that the invention is not limited to these Examples and may be embodied in various modifications and changes.

### Example 1

The following example illustrates a comparison in the change in color of single and mixed pH indicators according to an increase in lactic acid production amount.

In order to observe a change in color of the pH indicator according to an increase in an lactic acid production amount, solutions of a Bromocresol green indicator, a methyl red indicator and a mixed Bromocresol green/methyl red pH indicator (mixed ratio: 2:1) were prepared, respectively, and observed for change in color with the naked eye according to a change in pH while adding lactic acid to the indicator solutions.

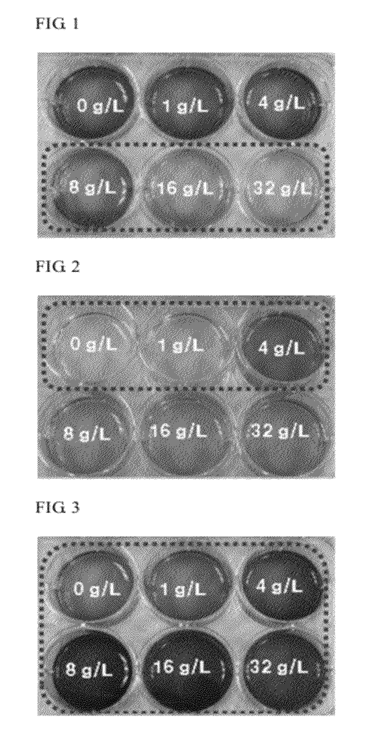

The results obtained by observing the change in colors of the pH indicators according to an increase in lactic acid production amount with the naked eye are listed in the following Table 3 and shown in FIGS. 1 to 3.

TABLE 3

| | lactic acid (g/L) | | | | | |
|---|---|---|---|---|---|---|
| | 0 | 1 | 4 | 8 | 16 | 32 |
| pH | 7.19 | 6.96 | 6.03 | 4.02 | 3.45 | 3.03 |
| Bromocresol | Blue | Blue | Blue | Green | Lime | Yellow |
| green | | | | | green | |
| Methyl red | Yellow | Dark | Orange | Red | Red | Red |
| | | yellow | | | | |
| Bromocresol | Green | Lime | Yellow | Violet | Dark | Red |
| green/methyl red | | green | | | red | |

When the Bromocresol green indicator is used, an accurate measurement of lactic acid production amount is not possible when the amount of lactic acid is very low (e.g., within a range of 0 to 8 g/L). A change in color of the indicator according to an increase in the lactic acid production amount is only observed when the lactic acid production amount is greater than 8 g/L. That is, a blue color is observed in a range of pH 7.19 to pH 5.4, and a change in color from blue to yellow is clearly observed in a pH range 5.4 or lower.

When the methyl red indicator is used, an accurate measurement of lactic acid production amount is not measured when production amount of lactic acid is within a range of 8 to 32 g/L. A change in color of the indicator according to an increase in the lactic acid production amount is observed only when the lactic acid production amount is less than 8 g/L. That is, a change in color from yellow to red is clearly observed in a range of pH 7.19 to pH 4.4, but a red color is observed in a pH range less than pH 4.4.

Meanwhile, in the case of the Bromocresol green/methyl red mixed pH indicators, a change in color in order of green, lime green, yellow, violet, dark red and red according to an increase in lactic acid production amount from approximately 0 to about 32 g/L is clearly observed with the naked eye. That is, the change in color is clearly observed in an entire range of pH 7.19 to pH 3.03.

Therefore, it is possible to determine the lactic acid production amount more accurately and easily using the Bromocresol green/methyl red mixed pH indicators.

### Example 2

The following example illustrates the use of mixed pH indicators in a high throughput screening of lactic acid-producing microorganism.

One thousand (1000) lactic acid-producing E. coli candidates are incubated in an M9 medium supplemented with 2% glucose, and screened using high-performance liquid chromatography (HPLC) to detect a lactic acid-producing strain having the highest lactic acid production amount.

An analytic speed with HPLC is 30 min/sample, and a time of approximately 21 days is required to identify the lactic acid-producing strain having the highest lactic acid production amount from the 1000 initial candidates.

Meanwhile, the mixed pH indicators in which Bromocresol green and methyl red were mixed at a ratio of 2:1 are added to the medium, and 1000 lactic acid-producing E. coli candidates are incubated in the medium. The change in color of the mixed pH indicators is observed to preliminarily screen 100 lactic acid-producing E. coli candidates whose color changed to red. These 100 lactic acid-producing strains having the highest lactic acid production amount, are then further screened using HPLC to identify the single highest lactic acid producing strain.

When the mixed pH indicators are used to preliminarily screen and identify the 100 highest lactic acid-producing E. coli candidates, it takes only approximately 2 days to screen for the single lactic acid-producing strain having the highest lactic acid production amount.

These results confirm that when the mixed Bromocresol green/methyl red pH indicators are used, the time required to screen the lactic acid-producing strain having the highest lactic acid production amount is shortened by about 90%.

While exemplary embodiments have been disclosed herein, it should be understood that other variations may be possible. Such variations are not to be regarded as a departure from the spirit and scope of exemplary embodiments of the present application, and all such modifications as would be obvious to one skilled in the art are intended to be included within the scope of the following claims.

What is claimed is:

1. A screening system of an lactic acid-producing microorganism comprising:
an lactic acid-producing microorganism,
a medium, and
a mixture of at least two pH indicators.

2. The screening system according to claim 1, wherein the lactic acid-producing microorganism is at least one selected from the group consisting of Bacillus sp., Streptococcus sp., Streptomyces sp., Staphylococcus sp., Enterococcus sp., Lactobacillus sp., Lactococcus sp., Clostridium sp., Geobacillus sp., Escherichia coli sp., Pseudomonas sp., Salmonella sp., Campylobacter sp., Helicobacter sp., Flavobactenum sp., Fusobacterium sp., Ilyobacter sp., Neisseria sp., Candida sp., Hansenula sp., Kluyveromyces sp., Pichia sp., Saccharomyces sp., Schizosaccharomyces sp., and Yarrowta sp.

3. The screening system according to claim 2, wherein the lactic acid-producing microorganism comprises a wild-type strain, a mutant strain or a recombinant strain.

4. The screening system according to claim 1, wherein the at least two pH indicators undergo a predetermined visible change in color upon exposure to a predetermined pH.

5. The screening system according to claim 1, wherein the at least two pH indicators have a pH transition range of about 2.4 or more.

6. The screening system according to claim 1, wherein the at least two pH indicators are each independently selected from the group consisting of methyl violet, cresol red, thymol blue, erythrosine disodium, 2,6-dinitrophenol, 2,5-dinitrophenol, methyl yellow, tetrabromophenol blue, bromophenol blue, congo red, methyl orange, ethyl orange, alizarin red, sodium alizarin, Bromocresol green, methyl red, chlorophenol red and Bromocresol purple.

7. The screening system according to claim 6, wherein the at least two pH indicators comprise Bromocresol green and methyl red.

8. The screening system according to claim 7, wherein the Bromocresol green and the methyl red are mixed at a ratio of about 2:1 to 10:1.

9. The screening system according to claim 1 comprising about 0.005 to 0.2 parts by weight, of the at least two pH indicators based on 100 parts by weight of the medium.

10. A screening method of an lactic acid-producing microorganism, comprising:
adding at least two pH indicators to a medium;
incubating an lactic acid-producing microorganism in the medium to which the at least two pH indicators are added; and
measuring a lactic acid production amount of the microorganism by observing a change in colors of the at least two pH indicators.

11. The screening method according to claim 10, wherein the lactic acid-producing microorganism is at least one selected from the group consisting of Bacillus sp., Streptococcus sp., Streptomyces sp., Staphylococcus sp., Enterococcus sp., Lactobacillus sp., Lactococcus sp., Clostridium sp., Geobacillus sp., Escherichia coli sp., Pseudomonas sp., Salmonella sp., Campylobacter sp., Helicobacter sp., Flavobactenum sp., Fusobacterium sp., Ilyobacter sp., Neisseria sp., Candida sp., Hansenula sp., Kluyveromyces sp., Pichia sp., Saccharomyces sp., Schizosaccharomyces sp., and Yarrowta sp.

12. The screening method according to claim 11, wherein the lactic acid-producing microorganism comprises a wild-type strain, a mutant strain or a recombinant strain.

13. The screening method according to claim 10, wherein the at least two pH indicators have a combined pH transition range of 2.4 or more.

14. The screening method according to claim 10, wherein the at least two pH indicators are each independently at least two selected from the group consisting of methyl violet, cresol red, thymol blue, erythrosine disodium, 2,6-dinitrophenol, 2,5-dinitrophenol, methyl yellow, tetrabromophenol blue, bromophenol blue, congo red, methyl orange, ethyl orange, alizarin red, sodium alizarin, Bromocresol green, methyl red, chlorophenol red and Bromocresol purple.

15. The screening method according to claim 14, wherein the at least two pH indicators comprise Bromocresol green and methyl red.

16. The screening method according to claim 15, wherein the Bromocresol green and the methyl red are mixed at a ratio in a range of about 2:1 to 10:1.

17. The screening method according to claim 10, wherein a content of the at least two pH indicators is provided in a range of about 0.005 to 0.2 parts by weight, based on 100 parts by weight of the medium.

18. The screening method according to claim 10, wherein a time required to carry out the steps of the screening method is less than or equal to about 36 hours.
